(19) United States
(12) Patent Application Publication
(10) Pub. No.: US 2010/0066026 A1
(43) Pub. Date: Mar. 18, 2010

(54) MAIN SEAL SYSTEM AND METHOD FOR USE IN AN ELECTRONIC DEVICE

(75) Inventors: JORGE L. GARCIA, PLANTATION, FL (US); SALVADOR P. MAGANA, WELLINGTON, FL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/210,638

(22) Filed: Sep. 15, 2008

(51) Int. Cl. E04B 1/682; F16J 15/02

(52) U.S. Cl. 277/316; 277/647

(57) ABSTRACT

A main sealing system (500) for use in an electronic device comprises a first half housing (501) and a second half housing (516) such that a sympathetic seal (525) is attached integrally with the first half housing (501). The second half housing (516) comprises an integrally formed compression surface (511) for biasing the sympathetic seal (525) in an outwardly manner to prevent fluid from entering a cavity (618) formed when the first half housing (501) and second half housing (516) are joined to form an enclosure for the electronic device.

### FIELD OF THE INVENTION

This invention relates to mechanical seals, and more particularly, to sympathetic seals used in electronic devices.

### BACKGROUND OF THE INVENTION

Seals used to protect components used in portable electronic devices are commonly used in order to protect an inner portion of the device from water, moisture and other outside elements. One type of seal most often used in these devices is a compression-type seal. Compression seals are probably the oldest and most common seal type where sealing is accomplished by tightening the seal along its edge such that it is compressed onto another mating surface. Compression seals, or gland seals, are used in such applications as compression packing, gaskets, and fluid sealing type devices. Compression packing seals often work to seal any number of fluids, including water, acids, solvents, gases, oil, and other chemicals, in a range of varying conditions, such as temperature and pressure. Thus, compression seals are a broad category that is manufactured in a wide array of shapes, sizes, and constructions using many different types of materials.

Prior art FIG. 1 illustrates a typical compression seal 100 used in an electronic device in an unassembled state. The electronic device includes a lower housing 101 which includes a compression seal 103 extending about its perimeter in a channel 105. In its unassembled state, an upper housing 107 may be positioned above the lower housing 101 before assembly. Prior art FIG. 2 illustrates a compression seal 200 used in an electronic device in its assembled state. When assembled, the lower housing 201, including the compression seal 203, is used in connection with a channel 205. When an upper housing 207 is mechanically fastened to the lower housing 201, this causes the compression seal 203 to deform in a manner such that the ends of the compression seal 203 extend outwardly filling the voids or “gland” within the channel 205. The original shape of the compression seal 203 is illustrated in phantom. This process is also known as a “gland fill”. Since the compression seal 203 prevents water or other fluids from entering the channel 205 due to its compressed fit within the channel 205, this enables electronics or other electronic components from being damaged due to water breaching the joint between the lower assembly 201 and upper assembly 207.

Still another type of seal commonly used in the prior art is “lip” seal. A lip seal comprises a flexible lip that rubs against an edge in a housing to prevent the leakage or ingress of both fluids and dirt. For proper installation, the seal lip typically points toward the medium being contained. Thus, the sealing orientation and direction is an important consideration depending on the type of application. The orientation and direction can be internal, external, symmetric, or axial. As with the compression seal, the lip seal may be press-fit into a housing bore with the sealing lip contacting another surface such that the lip seal may seal axially against a housing or machine component.

Prior art FIG. 3 illustrates a typical lip seal 300 in an unassembled state. A lower housing 301 is positioned below the lip seal 303 which is attached to the upper housing 305. The lip seal 303 generally extends diagonally at an angle toward an orthogonal portion 307 of the lower housing 301. Prior art FIG. 4 illustrates a typical lip seal 400 in an assembled state. When the lower housing 401 is mechanically fastened to the upper housing 405, this causes a deflection in the lip seal 403 allowing it to substantially fill the void 407 in the orthogonal portion of the lower housing 401. The original shape of the lip seal 403 is also shown in phantom. Thus, any water or other fluids which were to breach the joint between the lower housing 401 and upper housing 403 would be prevented from entering the interior section of these houses for preventing damage to printed circuit boards (PCBs) or other electronic components. This type of lip seal is also known as a “sympathetic” seal meaning that higher water pressures will increase the load of the lip seal against the mating seal surface. Thus, higher water pressures from increased submersion depths increases the effectiveness of the seal.

Thus, before selecting either a compression or lip seal, it is important to understand a number of specific parameters that can affect performance, such as the size of the cross section that is to be sealed, the media and its specific qualities, the type of electronic equipment, and the temperature and pressure of the media being sealed. Once these variables have been determined, the proper seal can be selected.

As will be appreciated by those skilled in the art, drawbacks for the standard compression type seal as seen in FIGS. 1 and 2 are that increased water pressures can tend to tear apart the seal. Hence, this type of seal is not as effective in situations requiring deeper submersion. Additionally, compression seals often require separate seal parts which can greatly complicate assembly. Compression seals also require glands to control the area of compression (a four sided box) which requires more space and is less space efficient for use with internal components. The drawbacks for lip type seals as shown in FIGS. 3 and 4 are the increased tooling complexity which requires tooling to mold the undercut of the lip seal. This tooling process often requires tooling “parting lines” which greatly reduce the reliability and repeatability in using this type of seal.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a prior art diagram illustrating a side view of a compression seal used with an electronic housing in an unassembled state.

FIG. 2 is a prior art diagram illustrating a side view of a compression seal used in an electronic housing in an assembled state.

FIG. 3 is a prior art diagram illustrating a side view of a lip seal used with an electronic housing in an unassembled state.

FIG. 4 is a prior art diagram illustrating a side view of a lip seal used with an electronic housing in an assembled state.

FIG. 5 illustrates a side cross-sectional view of a sympathetic main seal system for use in an electronic device in an unassembled state in accordance with an embodiment of the present invention.

FIG. 6 illustrates a side cross-sectional view of the sympathetic main seal system as shown in FIG. 5 using a plastic skin cover in an assembled state in accordance with an embodiment of the present invention.

FIG. 7 illustrates a side cross-sectional view of the sympathetic main seal system show in FIG. 6 showing the effects of water pressure on the seal in accordance with an embodiment of the present invention.

FIG. 8 illustrates a perspective view of the sympathetic main seal system which can be routed around screw bosses for use with a unique housing geometry in accordance with an embodiment of the present invention.

FIG. 9 illustrates a side cross-sectional view of the sympathetic main seal system where an upper housing includes a groove for increasing overmold bond surface area between housing components in accordance with an embodiment of the present invention.

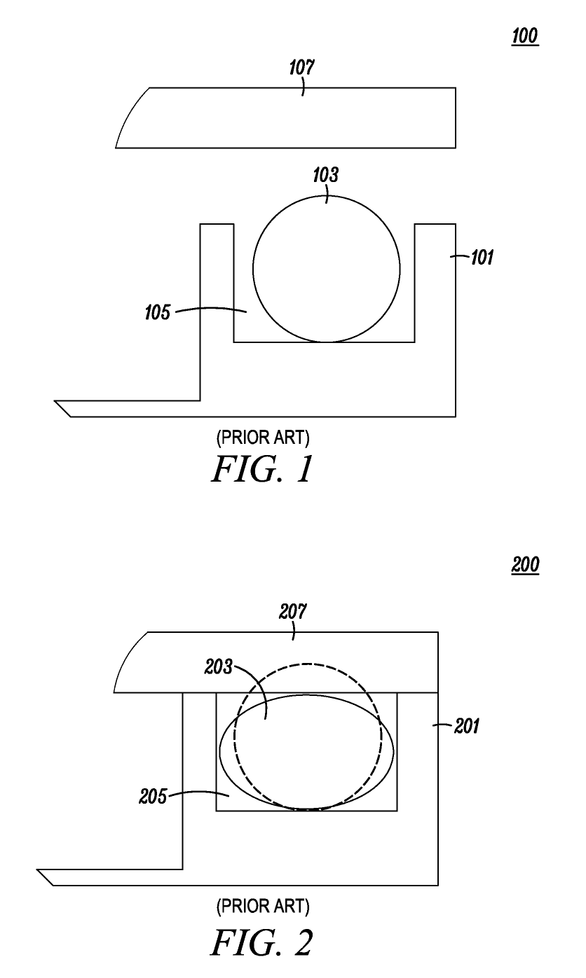

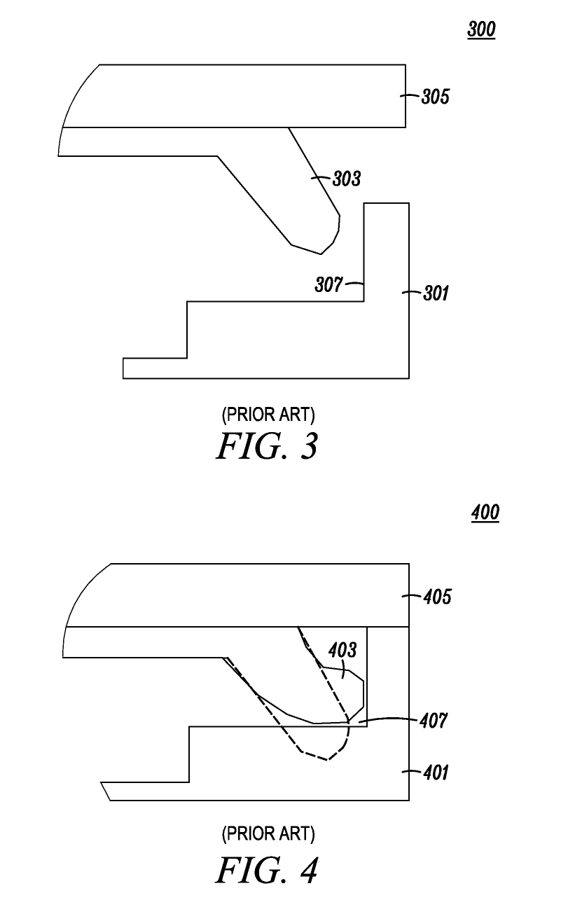

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a sympathetic seal system for use in an electronic device. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

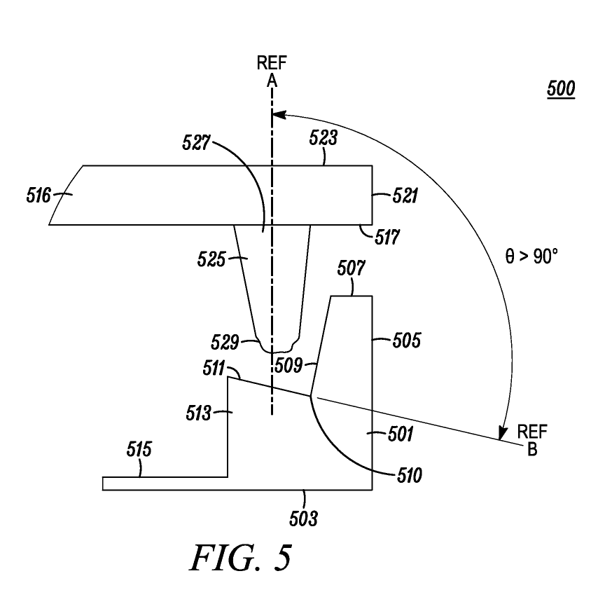

FIG. 5 illustrates a side view of a sympathetic main seal system 500 for use in an electronic device in an unassembled state in accordance with an embodiment of the present invention. The sympathetic main seal system 500 comprises a lower housing 501 which forms a portion of an electronic device (not shown). The lower housing 501 comprises an outside wall 503 which is orthogonal to a sidewall 505. The sidewall 505 is adjacent to an outer mating surface 507 which abuts an inner mating surface 517 which forms a portion of the upper housing 516. The outer mating surface 507 is adjacent to an angular wall 509 that forms an inner face extending angularly from the outer mating surface 507. A compression surface 511 extends from the angular wall 509 at an angle equal to or less than 90 degrees. As seen in FIG. 5, compression surface 511 is formed so that it forms an angle θ which is greater than 90 degrees between reference line A and reference line B.

Thus, an important aspect of the invention is that the compression surface 511 is angled outwardly with respect the direction of seal compression such that the compression surface 511 biases a sympathetic seal 525 (described hereinafter). When in compression, the sympathetic seal 525 moves in an outward manner from the interior of the internal cavity when the lower housing 501 and upper housing 516 are mated. Hence, an angular notch 510 that is formed at the intersection of the angular wall 509 and the compression surface 511 operate to bias the sympathetic seal into a substantially fixed position. A lateral wall 513 extends from the compression surface 511 toward the outside wall 503 such that an inner wall 515 is formed extending from the lateral wall 513.

Similarly, the upper housing 516 includes an inner mating surface 517 which substantially abuts the outer mating surface 507 when in an assembled state. The sidewall 521 is substantially orthogonal to the inner mating surface 517 where an outside wall 523 also extends orthogonally from the sidewall 521 forming an outer face of the upper housing 516. In order to form a watertight seal between the lower housing 501 and upper housing 516, the upper housing 516 comprises a sympathetic seal 525 which is overmolded around the perimeter of the upper housing 516. When not in compression, the sympathetic seal 525 has a substantially truncated conical shape in cross section that comprises a wide end 527 that is joined with the inner mating surface 517 and a truncated end 529. The truncated end 529 is used to mate within the angular notch 510.

As described herein, the seal 525 is manufactured of silicone or like material and is generally referred to as “sympathetic” in view of its existence and operation through an affinity, interdependence, or mutual association with various biasing components in the lower housing 501. In other words, the sympathetic seal 525 operates as a system in combination with the angular wall 509 and compression surface 511 used in the lower housing 510 for enabling the seal to operate more effectively as inward submersion pressure is increased. Hence, as the high pressure or “fluid” side of the sympathetic seal 25 is increased this acts to simultaneously increase the seal loading forces against the sealing surfaces, such as compression surface 511. Although some lip seals can operate in a similar “sympathetic” manner, the present invention is advantageous since it can be accomplished with much less tooling and overall complexity.

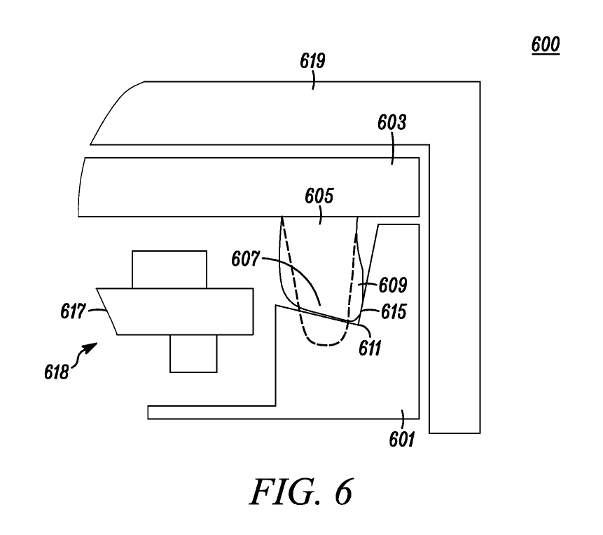

FIG. 6 illustrates a cross-sectional side view of the sympathetic main seal system 600 as shown in FIG. 5 in an assembled state. In contrast to FIG. 5, the lower housing 601 and upper housing 603 are joined in an assembled state and the original position of the sympathetic seal 605 is shown in phantom. Although not specifically shown herein, it should be evident to those skilled in the art that the lower housing 601 and upper housing 603 may be joined using any type of mechanical fasteners or other hardware in order to provide a substantially tight joint between castings forming a cavity 618.

In order to provide a watertight seal and prevent water or other fluids from entering the cavity 618 when subjected to submersion pressures, the sympathetic seal 605 is positioned within the angular notch 611. This acts to deform lower edge 607 and side edge 609 of the sympathetic seal 605. The sympathetic seal 605 deforms in a manner in order to prevent water or other fluids from extending substantially beyond the angular notch 611. This occurs in view of the substantially tight seal made between lower edge 607 and the compression surface 613 as well as between the side edge 609 and the angular wall 615. As seen in FIG. 6, the original shape of the sympathetic seal 605 is illustrated in phantom. Thus this seal is “sympathetic” since it ultimately works to prevent water and moisture from coming into contact with electronic components 617, which are placed in the void between the lower housing 601 and upper housing 603 as submersion pressure is increased.

Further, the invention may also comprise a plastic outer skin 619 which covers the lower housing 601 and upper housing 603. The plastic outer skin 619 is a “sealed alloy endoskeleton” concept such that the lower housing 601 and upper housing 603 are castings that are encased in a skin 619 manufactured from durable plastic or other synthetic materials that does not form a seal per se but rather serves to protect the casting structures from vibration and shock. The plastic skin 619 also comprises ergonomic advantages to the electric equipment such as a two-way portable transceiver, such that it provides improved hold, grip and overall controllability when operating the device.

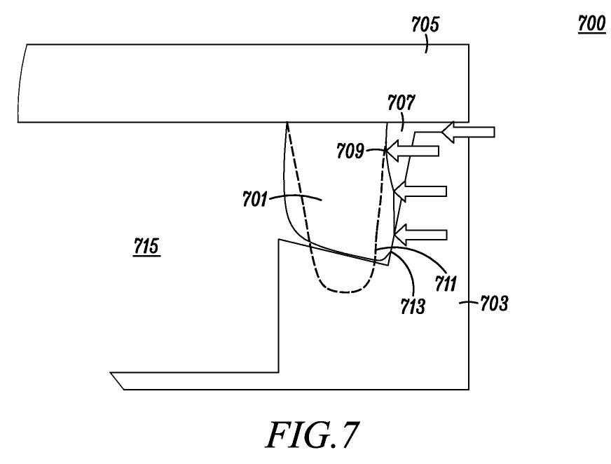

FIG. 7 illustrates a side cross-sectional view of the sympathetic main seal system 700, shown in FIG. 6, illustrating the affects of water pressure which may enter a gap located between the lower housing 703 and upper housing 705 when joined together. If the electronic device was submerged, water enters through a gap 707 formed between the joint between the upper and lower housings. As water enters the gap 707, a leverage force is applied to the sympathetic seal 701 such that side edge 709 works as a lever to apply a biasing force to the lower edge 711. As water pressure is increased, the force between the lower edge 711 and the angular wall 713 continues to increase its biasing force in order to prevent water or other liquids from breaching the interior 715 of the electronic device. In order to show deformation of the sympathetic seal 701, its original shape is also illustrated in phantom.

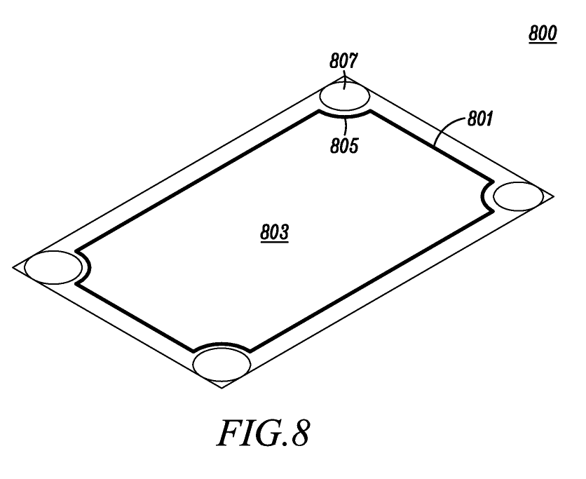

FIG. 8 illustrates a perspective view of the sympathetic main seal system 800 that is in a single plane and can be routed around screw bosses for use with a unique housing geometry. The sympathetic seal 801 is overmolded in single plane in a unitary or continuous manner to the upper surface of an electronic housing. The geometry of the seal 801 is flexible in that it may be jogged or routed in a semi-circular manner 805 around a screw boss 807 or other obstacle.

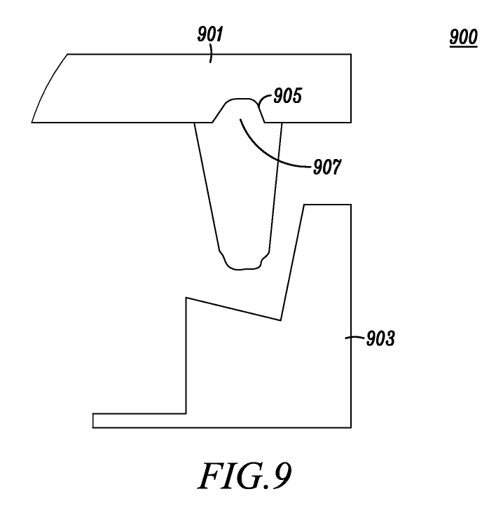

FIG. 9 illustrates a side cross-sectional view of the sympathetic main seal system 900 where upper housing comprises a groove for increasing overmold bond surface area between housing components. The upper housing 901 is joined with the lower housing 903 to form an enclosure such that the upper housing 901 comprises a groove 905 formed within the casting for increasing the overmold bond surface area of the sympathetic seal 907. Both the upper housing 901 and lower housing 903 are referred to herein as “housing”, and these components may be formed of a metallic alloy or the like to form individual castings. The groove 905 may be either rectangular or semi-circular in cross section for allowing the sympathetic seal 907 to expand into the groove cavity when in a compressed state. Since this results in an increase in the overall bond surface area, the use of the groove 905 works to further prevent water or other moisture from entering the cavity created between the upper housing 901 and lower housing 903.

Although specific embodiments of the present invention have been described, those of ordinary skill in the art will appreciate that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A main sealing system for use in an electronic device comprising:
a first half housing;
a second half housing;
a sympathetic seal attached integrally with the first half housing; and
wherein the second half housing includes at least one compression surface for biasing the sympathetic seal in an outward manner to prevent fluid from entering a cavity formed when the first half housing and second half housing are joined forming an enclosure for the electronic device.

2. A main sealing system for use in an electronic device as in claim 1, wherein the at least one compression surface forms an outward angle in the direction of compression of the seal that is greater than 90 degrees so as to bias the sympathetic seal outwardly while in a compressed state.

3. A main sealing system for use in an electronic device as in claim 1, wherein the sympathetic seal extends about the perimeter of the first half housing.

4. A main sealing system for use in an electronic device as in claim 1, wherein the first half housing and second half housing are metal castings.

5. A main sealing system for use in an electronic device as in claim 1, wherein the sympathetic seal forms a truncated conical shape.

6. A main sealing system for use in an electronic device as in claim 1, wherein the sympathetic seal comprises a wide end and a narrow end.

7. A main sealing system for use in an electronic device as in claim 1, wherein fluid entering between the first half housing and second half housing further biases the sympathetic seal against the compression surface for effectively increasing the compression force.

8. A main sealing system for use in an electronic device as in claim 1, wherein the sympathetic seal is in a single plane and circumvents around at least one screw boss.

9. A main sealing system for use in an electronic device as in claim 1, wherein the sympathetic seal is overmolded to the first housing half.

10. A main sealing system for use in an electronic device as in claim 1, wherein both the first housing half and second housing half are manufactured such that no tooling parting lines cross neither the sympathetic seal nor a compression surface.

11. A main sealing system for use in an electronic device as in claim 1, further comprising a plastic outer skin formed around the first half housing and second half housing.

12. A sympathetic sealing system for use with electronic equipment comprising:
a first casting having an overmolded sympathetic seal;
a second casting having an angular wall and at least one compression surface both forming an angular notch; and
wherein the sympathetic seal operates to provide a biasing force to the at least one compression surface when a levering force is provided by a fluid breaching a gap between the first casting and second casting which are joined to form an electronic housing.

13. A sympathetic sealing system as in claim 12, wherein the at least one compression surface forms an outward angle that is greater than 90 degrees in the direction of compression of the sympathetic seal so as to bias the sympathetic seal outwardly while in a compressed state.

14. A method for providing a main seal in an electronic device comprising the steps of:
forming a first half casting;
forming a second half casting;
attaching a sympathetic seal integrally with the first half casting;
forming at least one angular compression surface within the second half casting;
biasing the sympathetic seal outwardly towards the angular compression surface for preventing moisture from entering a cavity formed when the first half casting and second half casting are joined to form an enclosure for the electronic device.

15. A method for providing a main seal in an electronic device as in claim 14, further comprising the step of forming the at least one compression surface at an outward angle to the direction of seal compression such that the angle is greater than 90 degrees so as to bias the seal outwardly in its compressed state.

16. A method for providing a main seal in an electronic device as in claim 14, further comprising the step of routing the sympathetic seal about the perimeter of the first half casting.

17. A method for providing a main seal in an electronic device as in claim 14, further comprising the step of forming the first half casting and second half casting using a metallic alloy.

18. A method for providing a main seal in an electronic device as in claim 14, further comprising the step of forming the sympathetic seal into a truncated conical cross-sectional shape.

19. A method for providing a main seal in an electronic device as in claim 14, comprising the step of forming the sympathetic seal such that it includes a substantially wide end and a substantially narrow end.

20. A method for providing a main seal in an electronic device as in claim 14, further comprising the step of increasing a biasing force by the sympathetic seal to the at least one angular compression surface when a levering force is provided by a fluid breaching a gap between the first half casting and second half casting.

21. A method for providing a main seal in an electronic device as in claim 14, further comprising the step of forming the sympathetic seal in a single plane such that it can be positioned around at least one screw boss.

22. A method for providing a main seal in an electronic device as in claim 14, further comprising the step of overmolding the sympathetic seal to the to the first half casting.

23. A method for providing a main seal in an electronic device as in claim 14, further comprising the step of manufacturing both the first half casting and second half casting such that no tooling parting lines cross the seal nor a compression surface.

24. A method for providing a main seal in an electronic device as in claim 14, further comprising the step of forming a plastic outer skin around the sealed first half casting and second half casting.
